(19) United States
(12) Patent Application Publication
(10) Pub. No.: US 2026/0291834 A1
(43) Pub. Date: Sep. 24, 2026

(54) SERVICE QUALITY MONITORING OF WEBRTC TRAFFIC IN MOBILE NETWORKS

(71) Applicant: Telefonaktiebolaget LM Ericsson (PUBL), Stockholm (SE)

(72) Inventors: Attila Báder, PATY (HU); Gergely Dobreff, Budapest (HU); András Hering, Vanyarc Nógrád (HU); Márk Péter Szalay, Budapest (HU); Alija Pasic, Pilisvörösvár (HU); Márton Molnár, Ózd (HU); Bence Ladóczki, BUDAPEST (HU); László Varga, Rijen (NL)

(21) Appl. No.: 19/475,790

(22) PCT Filed: Apr. 17, 2023
(86) PCT No.: PCT/IB2023/053916

§ 371 Date: Oct. 16, 2025

(51) Int. Cl. H04L 41/5067; H04L 41/14; H04L 41/16

(52) U.S. Cl. CPC H04L 41/5067; H04L 41/14; H04L 41/16

(57) ABSTRACT

A method performed by a network node is presented. The method comprises obtaining an objective QoE model based on a first set of RTC session test data that correlates radio and transport parameters with associated RTC parameters across a plurality of network degradation levels. The method further comprises obtaining a subjective QoE model based on a second set of RTC session test data that correlates radio and transport parameters with associated RTC parameters across a plurality of network degradation levels. The second set of RTC session test data comprises fewer test sessions than the first set of RTC session test data. The method further comprises fitting the objective QoE model to the subjective QoE model at one or more cardinal measurement points. The method further comprises training the end-to-end QoE model based on the fitted objective QoE model.

### TECHNICAL FIELD

The present disclosure generally relates to communication networks, and more specifically to service quality monitoring of WebRTC traffic in mobile networks.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Fifth Generation (5G) will become the dominant radio access technology in the upcoming years and shape the future of mobile communications by enabling a wide range of new services and use cases (H. Holma, A. Toskala, T. Nakamura, “5G Technology: 3GPP New Radio”, John Wiley & Sons, December 2019). 5G New Radio (NR), a novel air interface developed by Third Generation Partnership Project (3GPP), is designed to satisfy the demands of emerging Ultra-Reliable Low-Latency Communication (URLLC) services, including 360-degree video streaming, cloud gaming, immersive Augmented Reality/Virtual Reality (AR/VR) applications, remote control and industrial automation.

Unlike mobile broadband (MBB) traffic, which typically needs high-bandwidth connections with only best-effort latency, URLLC types of services have stringent requirements on latency and reliability due to their real-time nature. Adaptive video streaming, which drives mobile traffic growth in terms of data volume, is tolerant to network Quality of Service (QoS) changes because client-side buffers are able to mask delay fluctuations originating from either the underlying transport mechanisms or the application itself.

In contrast, for low-latency communication data delivery must be ensured within specific latency bounds with at least 99.999 percent probability, depending on the given use case (Mangla, E. Halepovic, M. Ammar, E. Zegura, “Using Session Modeling to Estimate HTTP-Based Video QoE Metrics from Encrypted Network Traffic”, IEEE Transactions on Network and Service Management, vol. 16, no. 3, pp. 1086-199 September 2019). For example, while cloud gaming platforms can deliver lag-free gaming experience with up to 100 millisecond (ms) of round-trip time in some cases, industrial robots cannot operate reliably unless latency is kept under 5 ms.

Due to the strict constraints of delay and loss critical services, it is of utmost importance for mobile network operators (MNOs) to detect quality impairments and react swiftly to performance degradations through automated closed-loop actions. However, pervasive end-to-end encryption hinders the development of reliable traffic monitoring solutions that could lead to suboptimal user experience and eventually dissatisfied customers. The main technological driver behind encryption is the introduction of new protocols, which put more focus on security and privacy aspects by design than ever before. Specifically, the latest version of Transport Layer Security (TLS) and its variant tailored for User Datagram Protocol (UDP)-based data transmission (DTLS), provide enhanced security over their predecessors by means of forward secrecy and encrypted handshakes.

To measure service quality, MNOs usually deploy passive probes in their networks, which are capable of collecting packet-level information needed to calculate meaningful metrics for various types of network traffic. Earlier approaches to predicting Quality of Experience (QoE) mainly consisted of simplified analytical models built on human expert knowledge and observations (W3C WebRTC parameters, Identifiers for WebRTC's Statistics API, Recommendation draft 2022 July Identifiers for WebRTC's Statistics API (w3.org)).

In the era of encryption, leveraging the power of machine learning seems to be the most viable solution that can extract relevant patterns from raw traffic features and publicly accessible packet headers. While adequate methods for the QoE assessment of traditional MBB applications are already available, the traffic characteristics of URLLC services and their complex relationship with user-perceived quality are barely understood. To develop accurate performance metrics and models, extensive studies may need to be conducted that require a vast amount and diverse set of labeled data obtained under various network and radio conditions.

One significant group of URLLC services, such as web conferences and cloud gaming, use Web Real-Time Communication (WebRTC) technology. WebRTC enables real-time communication capabilities for application using open standards. It supports video, voice, and generic data to be sent between peers, facilitating powerful voice- and video-communication solutions. The technologies behind WebRTC are implemented as an open web standard and available as regular JavaScript Application Programming Interfaces (APIs) in major browsers as well as for mobile applications. Services using WebRTC technology usually use parallel bidirectional audio and video flows.

To enable monitoring service quality of WebRTC traffic, the World Wide Web Consortium (W3C) standardization organization has specified a number of WebRTC parameters, which are implemented and monitored by major web browsers.

Per session advanced analytics systems are based on collecting and correlating elementary network events from different network domains, such as core, radio and transport networks. These systems calculate user and session level end-to-end service quality metrics, e.g. Key Performance Indicators (S-KPIs) or QoE as well as radio and network resource KPIs (R-KPIs), characterizing radio environment or network operation at the user and session level. These types of solutions are suitable for session-based troubleshooting and analysis of network issues.

Event based analytics systems are also used in Service Operation Centers (SOC) for monitoring the quality of the wide variety of services used in the network level, as well as for monitoring the customer experience on individual per subscriber level. These tools are widely used in customer care and other scenarios.

Event based analytics require real-time collection and correlation of characteristic node and protocol events from different radio and core nodes, probing signaling interfaces (IFs) and sampling of the user-plane traffic as well. Beside the data collection and correlation functions, the system requires an advanced database, rule engine and big data analytics platform as well.

Because of the introduction of 5G mobile networks, it is expected that mobile networks will serve (and provide quality of service, quality of experience) a large variety of new service types, including WebRTC ones. In addition, it is expected that these networks will serve a much higher number of devices or user equipment (UEs) than in previous network technologies.

There currently exist certain challenges. For example, the WebRTC traffic is, in most cases, encrypted by TLS. The packet payload and some parts of the protocol header fields are, therefore, hidden for passive monitoring (i.e. for network probes). It is difficult to observe the frame structure of traffic and determine service quality.

In another example, the existing QoE monitoring based on network probing methods are tailored for legacy MBB use reliable transport, e.g. TCP. These cannot be applied to real-time delay and loss critical services.

In another example, obtaining end-to-end transport metrics (latency, packet loss, jitter, etc.) is difficult or not possible only by network probing, because in many cases END-TO-END transport report is missing, or END-TO-END metrics should be derived from multiple path segments, and the resolution of data are different, or data for certain segments are not available. In summary, adequate solutions providing END-TO-END, network-wide service quality monitoring for WebRTC traffic is not available.

In another example, end user service quality parameters, such as W3C WebRTC stat parameters can be obtained for limited number of test devices and these are not available for network operators for all sessions/clients.

Service quality machine learning (ML) models and model training require adequate amount and accurate test data, which includes reference data of the expected output (which can be used as ground truth). Collecting subjective QoE measurements is time consuming, expensive and usually possible to obtain only for a limited number of sessions, and limited number of media types. The subjective determination of QoE and/or QoE degradation of the session are inexact.

In another example, many QoE models depend not only on the transmission quality but also on the media content, the used end devices, etc, factors for which network operators have less or no control. The primary use case for network operators is detecting and fixing service quality degradations caused by network problems. Therefore, QoE models that are more sensitive to network degradation and depend less on the media content are required.

### SUMMARY

Based on the description above, certain challenges currently exist with service quality (e.g., QoE) monitoring of WebRTC traffic in mobile networks. Certain aspects of the present disclosure and their embodiments may provide solutions to these or other challenges. For example, some embodiments provide a method and system for mobile networks suitable for monitoring network-wide the service quality of the encrypted WebRTC traffic in mobile network. Some embodiments of the system can primarily be used for identifying and fixing transport and radio network issues influencing the service quality of WebRTC traffic types.

Some embodiments of the network-wide system monitors transport and radio environment parameters at the core network and radio base stations. The monitored transport parameters may include bitrate, throughput, packet loss, jitter, interarrival time and burst metrics, which are available and possible to monitor for TLS encrypted traffic flows as well. Monitored radio parameters may include downlink signal strength, uplink transmitted power, interference as well as handover parameters, namely Reference Signal Received Power (RSRP), Reference Signal Received Quality (RSRQ), Physical Uplink Shared Channel (PUSCH), Cell Identification (CID). The resolution of these measurements is in the range of 1-10 seconds(s).

In some embodiments, the actual service quality, i.e. QoE is estimated by a network END-TO-END service quality model, which uses the above transport and radio parameters as input.

In some embodiments, the END-TO-END service quality model is trained with test sessions measured at different transport and radio degradation scenarios. These scenarios may include packet loss, jitter, bandwidth limitations, bit corruption, radio shielding, bad coverage, handover with different level of degradations. The scenarios may include mixed degradation cases as well (e.g. packet loss and jitter).

In some embodiments, the reference value or ground truth for the training of the end-to-end service quality model is provided by an objective QoE model. The objective QoE model is based on W3C WebRTC stat parameters measured at the end client. The correlation of the WebRTC parameters with the different network degradations, as well as with the network-wide measurable transport and radio parameters are obtained for step and multistep degradation functions. The most correlating WebRTC parameters are selected as input for the objective QoE model. At cardinal measurement points standard Subjective QoE measurements are performed. The Objective QoE model is fitted to these measurement points. The Subjective QoE measurements have to be executed for a limited number of sessions (10-100), while Objective QoE can be obtained for a much large number of training sessions for many degradation scenarios.

Once the end-to-end service quality model is trained, it provides QoE estimates for WebRTC traffic near real-time with 1-10 s time resolution for Network Data Analytics Function (NWDAF), Management Data Analytics Function (MDAF), etc. use cases.

According to some embodiments, a method and concept of estimating QoE in mobile networks for WebRTC traffic types, by establishing the relationship between network-wide measurable radio and transport parameters for encrypted traffic and end user perceived service quality in the following way:
Test measurements are performed in good network conditions, different network and radio degradation scenarios. Single error and mixed error meas. scenarios are performed. For example, good network conditions may be referred to as network conditions that satisfy network criteria threshold, such as latency less than a threshold, jitter less than a threshold, package loss less than a threshold, bandwidth limitation less than a threshold, bit corruption less than a threshold, and the like.
W3C WebRTC stat (i.e., standard) parameters, radio and transport parameters are measured at end client in the above measurement scenarios.
In the same measurements, transport and radio parameters that are possible to obtain in the real network as well are also measured.
An Objective QoE model is constructed based on the correlation of the WebRTC parameters with network errors.
Subjective QoE scores are obtained for limited number of test scenarios, The Objective QoE is fitted to the Subjective QoE at the cardinal points.
The most correlating transport and radio parameters with the network errors are used as input to the end-to-end QoE model. For example, the most correlating transport and radio parameters may be referred to as transport and radio parameters that are correlated with and/or affected by the network errors more than a threshold percentage compared to other parameters.
The end-to-end QoE model is trained with the Objective QoE as ground truth for the test session.
QoE is estimated during operation for all WebRTC sessions with the trained end-to-end QoE model.

According to some embodiments, a method of constructing the Objective QoE model may comprise the following operations:
Obtain the correlation of all W3C parameters and the primary degradation parameter by fitting the time series measurements for single- and multistep measurements with different level of degradations.
Select the most correlated WebRTC parameters per degradation type. For example, the most correlated WebRTC parameters may include WebRTC parameters that are correlated with and/or affected by the network errors more than a threshold percentage compared to other WebRTC parameters.
Obtain a common set of parameters as union of the selected parameters for the different degradation types.
Obtain the Objective QoE as a weighted function of the selected WebRTC parameters, based on the correlation factor of the different parameters.
Exclude parameters which are content dependent or decrease the weight of parameters which are content dependent.
Subtract, take into account the correlation among the WebRTC parameters.
Fit the Objective QoE function to Subjective QoE measurements at cardinal points.

According to some embodiments, the selected WebRTC parameters may be used for the Objective QoE model.

According to some embodiments, the selected transport and radio parameters, which are needed for network-wide monitoring and well correlate with the selected WebRTC parameters may be used as input to the end-to-end QoE model.

Comparing to subjective QoE, objective QoE is more exact and possible to obtain for larger number of test session automatically. As a consequence, the ML model trained by objective QoE will be more accurate.

The objective QoE model, the WebRTC parameters, transport and radio parameters were selected to correlate well with the different network issues. Therefore, the QoE estimation is expected to indicate the network related service quality degradations accurately, which are required for important NWDAF and MDAF use cases.

The correlation were obtained for step functions, simulating sudden change between good and degraded periods. Therefore, it is expected that the most correlating parameters indicate sudden network issues in the live network accurately as well.

The selected WebRTC, transport and radio parameters correlate well with each other, ensuring accurate end-to-end QoE estimation.

According to some embodiments, web parameters that depend on the media content are excluded or included with low weight, therefore, the model is less content dependent, focuses more on network conditions.

Particular embodiments provide certain technical advantages. For example, the selected radio and transport parameters can be measured for all WebRTC session with high enough resolution real-time, therefore, QoE can be obtained for all WebRTC sessions real-time or near real-time.

In another example, the selected transport parameters can be measured network-wide for encrypted traffic. Therefore, QoE can be obtained for encrypted traffic as well. The packet parameters measured on the encrypted traffic is used as input to the ML model.

According to some embodiments, a method is performed by a network node for training an end-to-end QoE machine learning model for encrypted RTC traffic (e.g., WebRTC). The method comprises obtaining an objective QoE model based on a first set of RTC session test data that correlates radio and transport parameters with associated RTC parameters across a plurality of network degradation levels. The method further comprises obtaining a subjective QoE model based on a second set of RTC session test data that correlates radio and transport parameters with associated RTC parameters across a plurality of network degradation levels, where the second set of RTC session test data comprises fewer test sessions than the first set of RTC session test data. The method further comprises fitting the objective QoE model to the subjective QoE model at one or more cardinal measurement points. The method further comprises training the end-to-end QoE model based on the fitted objective QoE model.

In particular embodiments, the radio parameters may comprise at least one of RSRP, RSRQ, Cell Identification (CID) for handover, PUSCH transmit power, and Physical Uplink Control Channel (PUCCH) transmit power.

In particular embodiments, the transport parameters may comprise at least one of an average or standard deviation interarrival time, an average or standard deviation burst length, a bitrate, a packet loss percentage, an average Round Trip-Delay (RTT), and an average jitter.

In particular embodiments, the RTC parameters may comprise at least one of currentRoundTripTime, jitter, packetsSent, packetLost,availableOutgoingBitrate, jitterBufferDelay_diff, sumOfSquaredFramesDuration_diff, interFrameDelayStDev_in_ms, jitterBufferDelay/jitterBufferEmittedCount_in_ms, jitterBufferDelay_diff, framesReceived, and framesReceived/framesDecoded.

In particular embodiments, the objective QoE model may be determined based at least on a weighted average of the RTC parameters. In particular embodiments, the weighted average of the RTC parameters is determined based at least on weight values that correspond to average correlation coefficients between each of the RTC parameters, each of the radio and transport parameters, and at least one network degradation parameter.

In particular embodiments, the objective QoE function is as below:

$${QoE}_{norm} = {\sum }_{i}^{n} {w}_{i} {P}_{i} - {\sum }_{jk}^{nn} {c}_{jk} {P}_{j} {P}_{k}$$

where, QoEₙₒᵣₘ is a normalized objective QoE value, Wᵢ is an average correlation coefficient for at least one network degradation level and an associated RTC parameter Pᵢ, Cⱼₖ is a correlation coefficient between RTC parameters Pⱼ and Pₖ, each of i, n, k, j is a number, and a cross correlation among RTC parameters cⱼₖPⱼPₖ is subtracted from a weighted average of a subset of RTC parameters wᵢPᵢ.

In particular embodiments, correlating radio and transport parameters with associated RTC parameters across the plurality of network degradation levels comprises excluding a content-dependent RTC parameter from consideration. In particular embodiments, correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.

In particular embodiments, the plurality of network degradation levels is based on any one or more of the following parameters: packet loss, jitter, bandwidth limitation, bit corruption, radio shielding, coverage less than a threshold, and handover with different level of network degradations.

In particular embodiments, the one or more cardinal measurement point comprises at least one of the following: a first point where no network degradation is injected into the encrypted RTC traffic, a second point where an objective QoE value starts to degrade for a given network degradation, a third point where an objective QoE value has the least value, and one or more intermediate points between each pair of the first point, the second point, and the third point.

According to some embodiments, a method is performed by a network node for determining an end-to-end QoE estimation of encrypted RTC traffic (e.g., WebRTC) comprises obtaining an end-to-end QoE model trained based on an objective QoE model based on a first set of RTC session test data that correlates radio and transport parameters with associated RTC parameters across a plurality of network degradation levels that is fitted to a subjective QoE model at one or more cardinal measurement points. In particular embodiments, the subjective QoE model may be based on a second set of RTC session test data that correlates radio and transport parameters with associated RTC parameters across a plurality of network degradation levels. In particular embodiments, the second set of RTC test session data comprises fewer test sessions than the first set of RTC session test data.

The method further comprises estimating a QoE value for an RTC session based on a given set of radio and transport parameters as input to the end-to-end QoE model.

In particular embodiments, the radio parameters may comprise at least one of RSRP, RSRQ, CID for handover, PUSCH transmit power, and PUCCH transmit power.

In particular embodiments, the transport parameters may comprise at least one of an average or standard deviation interarrival time, an average or standard deviation burst length, a bitrate, a packet loss percentage, an average RTT, and an average jitter.

In particular embodiments, the RTC parameters may comprise at least one of currentRoundTripTime, jitter, packetsSent, packetLost,availableOutgoingBitrate, jitterBufferDelay_diff, sumOfSquaredFramesDuration_diff, interFrameDelayStDev_in_ms, jitterBufferDelay/jitterBufferEmittedCount_in_ms, jitterBufferDelay_diff, framesReceived, and framesReceived/framesDecoded.

In particular embodiments, the objective QoE model may be determined based at least on a weighted average of the RTC parameters. In particular embodiments, the weighted average of the RTC parameters is determined based at least on weight values that correspond to average correlation coefficients between each of the RTC parameters, each of the radio and transport parameters, and at least one network degradation parameter.

In particular embodiments, the objective QoE function is as below:

$${QoE}_{norm} = {\sum }_{i}^{n} {w}_{i} {P}_{i} - {\sum }_{jk}^{nn} {c}_{jk} {P}_{j} {P}_{k}$$

where, QoEₙₒᵣₘ is a normalized objective QoE value, Wᵢ is an average correlation coefficient for at least one network degradation level and an associated RTC parameter Pᵢ, Cⱼₖ is a correlation coefficient between RTC parameters Pⱼ and Pₖ, each of i, n, k, j is a number, and a cross correlation among RTC parameters cⱼₖPⱼPₖ is subtracted from a weighted average of a subset of RTC parameters wᵢPᵢ.

In particular embodiments, correlating radio and transport parameters with associated RTC parameters across the plurality of network degradation levels comprises excluding a content-dependent RTC parameter from consideration. In particular embodiments, correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.

In particular embodiments, the plurality of network degradation levels is based on any one or more of the following parameters: packet loss, jitter, bandwidth limitation, bit corruption, radio shielding, coverage less than a threshold, and handover with different level of network degradations.

In particular embodiments, the one or more cardinal measurement point comprises at least one of the following: a first point where no network degradation is injected into the encrypted RTC traffic, a second point where an objective QoE value starts to degrade for a given network degradation, a third point where an objective QoE value has the least value, and one or more intermediate points between each pair of the first point, the second point, and the third point.

According to some embodiments, a network node comprises a processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, some embodiments provide a method and system for mobile networks suitable for monitoring network-wide the service quality of the encrypted WebRTC traffic in mobile network. Some embodiments of the system can primarily be used for identifying and fixing transport and radio network issues influencing the service quality of WebRTC traffic types.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is an example system architecture including a network, an analytics system, collected data during operation and for test sessions, according to certain embodiments;

FIG. 2 is an example operation of obtaining QoE estimations for WebRTC traffic, according to certain embodiments;

FIG. 3a illustrates example single step measurements for packet loss at different degradation levels (10% and 20%), according to certain embodiments;

FIG. 3b illustrates example multi step measurements for packet loss in the range of 5-40% packet loss degradation, according to certain embodiments;

FIG. 4 illustrates an example correlation matrix among all parameters in case of packet loss degradation, according to certain embodiments;

FIG. 5 illustrates the most correlating transport, radio and WebRTC parameters different degradation types, according to certain embodiments;

FIG. 6 illustrates an example fitting the Objective QoE model to Subjective QoE at cardinal measurement points, according to certain embodiments;

FIG. 7 illustrates an example end-to-end service quality model, according to certain embodiments;

FIG. 8 is a block diagram illustrating an example wireless network;

FIG. 9 illustrates an example user equipment, according to certain embodiments;

FIG. 10 is flowchart illustrating an example method in a network node, according to certain embodiments;

FIG. 11 is flowchart illustrating an example method in a network node, according to certain embodiments; and

FIG. 12 illustrates a schematic block diagram of a network node in a wireless network, according to certain embodiments.

### DETAILED DESCRIPTION

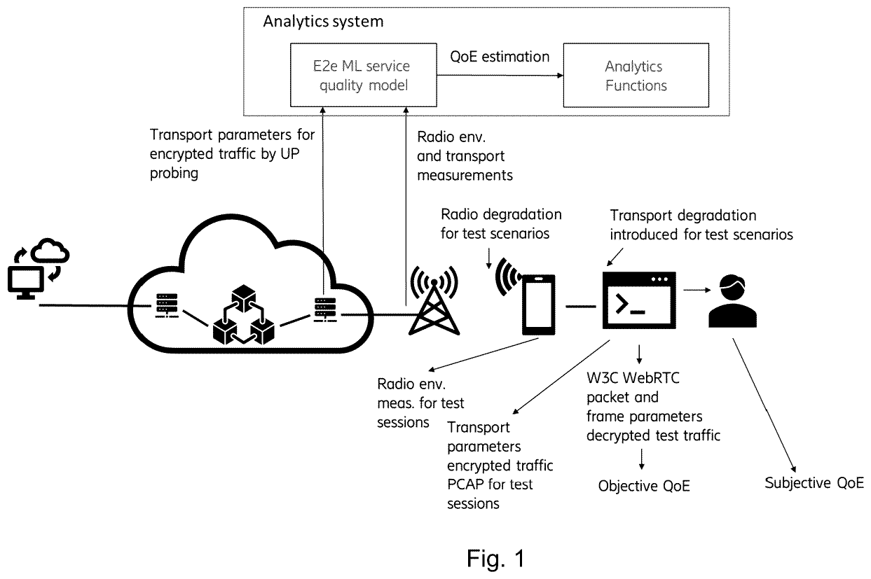

Based on the description above, certain challenges currently exist with service quality (e.g., QoE) monitoring of WebRTC traffic in mobile networks. Certain aspects of the present disclosure and their embodiments may provide solutions to these or other challenges. For example, some embodiments provide a method and system for mobile networks suitable for monitoring network-wide the service quality of the encrypted WebRTC traffic in mobile network. Some embodiments of the system can primarily be used for identifying and fixing transport and radio network issues influencing the service quality of WebRTC traffic types. FIG. 1 is an example system architecture including a network, a analytics system, collected data during operation and for test sessions, according to certain embodiments. As shown in FIG. 1, the network consists of a core and radio network domains. During operation, the user plane traffic is monitored by network probes or probe functions in the core network user plane function (UPF), while the radio environment measurements measured by UEs are collected and reported by radio base stations (gNB, eNB). Analytics system receives the probe and radio reports real-time and correlate the measurements per session. end-to-end service quality model estimates the QoE. Typical time resolution of probe reports and radio measurements are 1-10 s, The ML model also reports QoE with 1-10 s resolution. QoE is used for various analytics use cases in Analytics Functions, e.g. NWDAF, MDAF.

In some embodiments, the end-to-end QoE model is trained by test sessions. Test sessions are executed and measured by any suitable method. Radio environment data are measured at the UE. Transport degradations are introduced at the input IF of the test system, (package capture) pcap is captured at a virtual IF within the test system following the degradation. W3C WebRTC parameters are logged at the end client. Radio degradation is provided by shielding the physical radio IF. Subjective QoE is obtained by human tests, evaluating the audio-video streams for part of the test sessions.

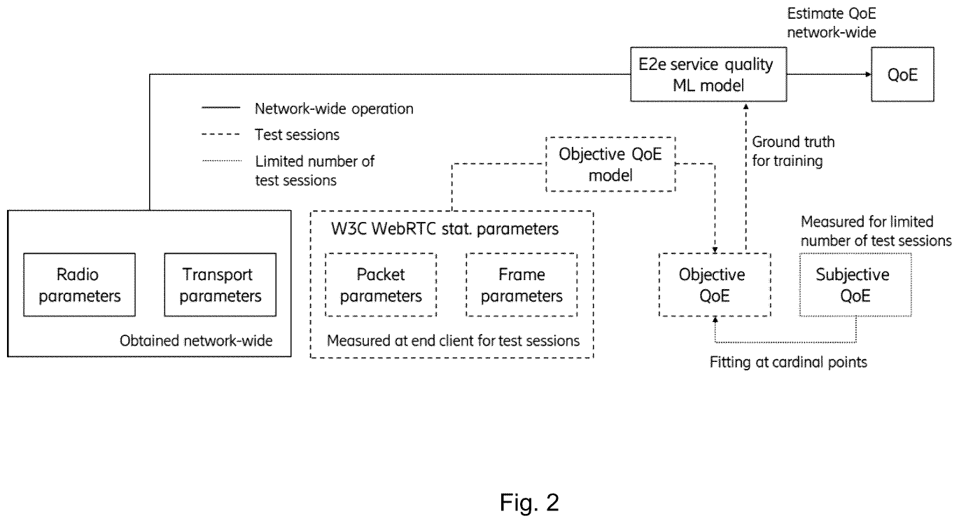

FIG. 2 is an example operation of obtaining QoE estimations for WebRTC traffic, according to certain embodiments. In some embodiments, radio and transport parameters are obtained for all WebRTC sessions (operation and test sessions), for encrypted traffic. W3C WebRTC stat parameters are measured for all test sessions (few 100 to few 1000 sessions). Test sessions are taken at good and bad transport and radio conditions, covering any possible degradation types and different level of degradations. For example, good transport and radio conditions may be referred to as conditions that satisfy network criteria threshold, such as latency less than a threshold, jitter less than a threshold, package loss less than a threshold, bandwidth limitation less than a threshold, bit corruption less than a threshold, and the like. In another example, bad transport and radio conditions may be referred to as conditions that do not satisfy the network criteria threshold.

In some embodiments, test sessions are measured at mixed degradation scenarios. Objective QoE model is constructed based on selected WebRTC parameters. Subjective QoE is measured by human tests for a limited number of test sessions for cardinal measurement conditions (few 10 or 100 sessions), e.g. by method, protocol described in “subjective test methodology for assessing impact of initial loading delay on quality of experience, Recommendation ITU-T P.917” or any other suitable method. Objective QoE model is fitted to subjective QoE measurements at the cardinal points. end-to-end QoE model is trained by the test sessions, using Objective QoE values as expected reference value (ground truth).

End-to-end service quality ML model is evaluated by using a part of the training session. In this case, the measured radio and transport parameters are used as input and the estimated QoE is compared with the corresponding Objective QoE and Subjective QoE scores.

### Measurement Scenarios

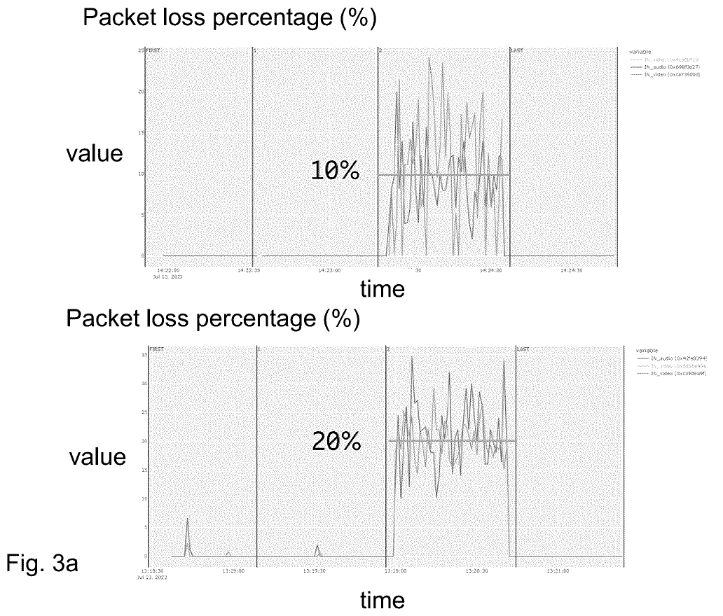

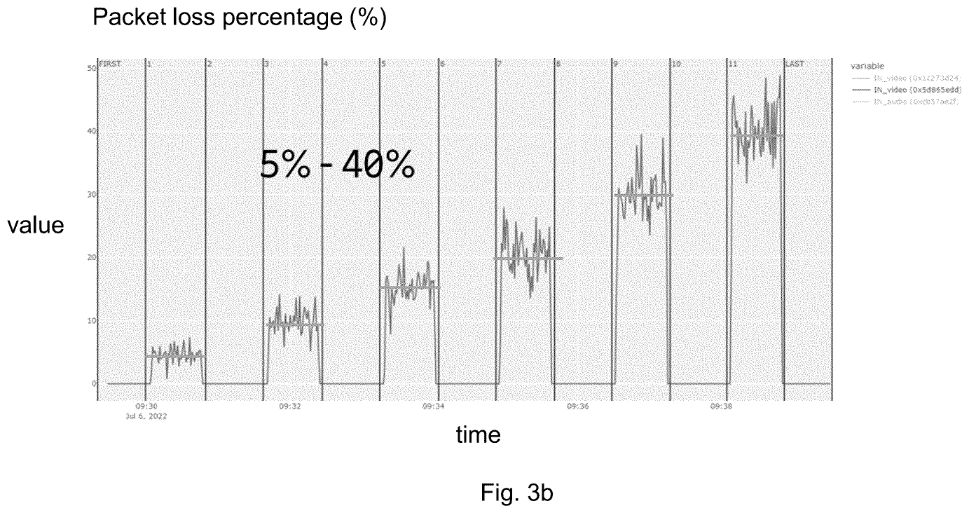

The test sessions are measured at good and different radio and transport degradation conditions, according to certain embodiments. The measurements are performed for step and multistep degradation functions covering a reasonable degradation range and good network conditions as well (See FIGS. 3a and 3b). In order to train the QoE model for various network issues, in particular embodiments, as many degradation types and levels as possible are included in the test scenarios.

FIG. 3a illustrates example single step measurements for packet loss at different degradation levels (e.g., 10% and 20%), according to certain embodiments. The measurements include the measured WebRTC packet loss parameters for video and audio and video retransmission streams.

FIG. 3b illustrates example multi step measurements for packet loss in the range of 5-40% packet loss degradation, according to certain embodiments. In some embodiments, the measurement scenarios for test sessions are included the following degradation types and parameter ranges:
Radio (shielding, low coverage, handover)
Packet loss (5-40%)
Delay, jitter (50-200 ms)
Band width (BW) limitation (200-2000 kilo bit per second (kbps))
Background traffic (1-2 mega bit per second (Mbps))
Bit corruption (0.1-1%)
Mixed scenarios, combination of the above cases.

The service types for which the tests are executed include video conference applications, audio-video streaming applications, and the like.

### Parameter Correlation, Selecting the Most Significant Parameters

In some embodiments, the measured parameters are classified to different groups, such as the following:
1. Transport parameters (possible to measure at core network UPF);
2. Radio parameters (measured by UE and reported by the radio base stations);
3. WebRTC stat packet parameters; and
4. WebRTC stat frame parameters.
5. WebRTC stat buffer-related parameters.

In some embodiments, the correlation among the parameters, within and among the above groups are obtained for the step and multistep time series function per degradation type.

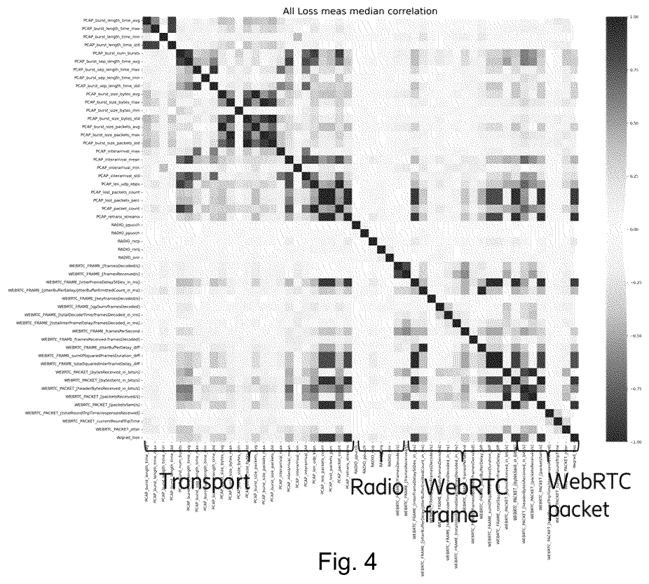

An example of correlation matrix is shown in FIG. 4. The darker the pixel the stronger the correlation is between the two parameters.

FIG. 4 illustrates an example correlation matrix among all parameters in case of packet loss degradation, according to certain embodiments. The most correlating parameters per degradation type are selected (See FIG. 4), according to certain embodiments.

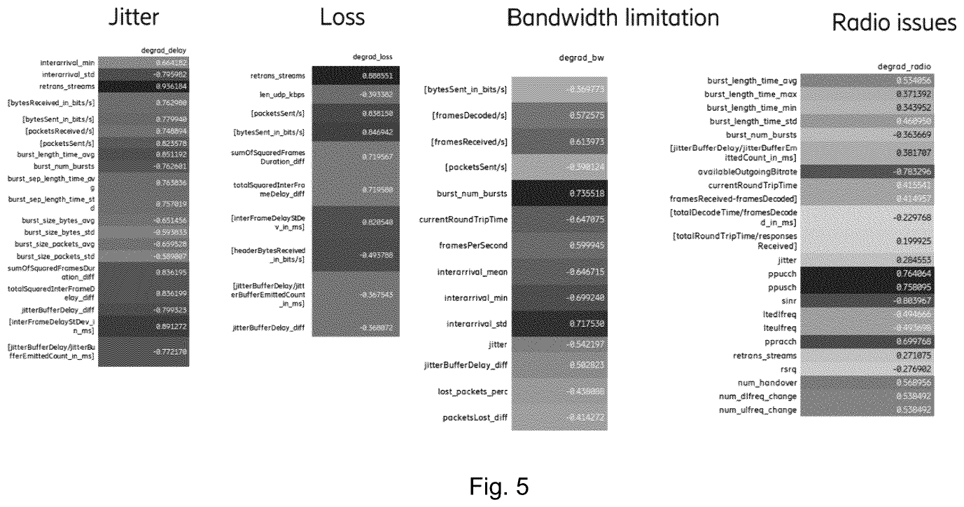

FIG. 5 illustrates the most correlating transport, radio and WebRTC parameters different degradation types, according to certain embodiments. In the following step, a common set of parameters for all degradation types are obtained, e.g. as the union of the most significant parameters. In some embodiments, between each parameter pairs, which strongly correlate with each other within the parameter groups (transport, radio, WebRTC packet, WebRTC frame and WebRTC buffer) only one is selected. In some embodiments, content dependent parameters are excluded or taken into account with decreased weight.

In some embodiments, the following radio and transport parameters are selected as input to the end-to-end QoE model:

Selected radio parameters: RSRP, RSRQ, CID (for handover (HO)), PUSCH.

Selected transport parameters: Interarrival time avg and stdev, Burst length avg and stdev, Bitrate, Packet loss %, round trip time (RTT) avg, Jitter avg.

In some embodiments, the following WebRTC parameters are selected as possible parameters for the Objective QoE model:
currentRoundTripTime, jitter, packetsSent, packetLost,availableOutgoingBitrate, jitterBufferDelay_diff, sumOfSquaredFramesDuration_diff, interFrameDelayStDev_in_ms, jitterBufferDelay/jitterBufferEmittedCount_in_ms, jitterBufferDelay_diff, framesReceived, framesReceived/framesDecoded.

As an example, the objective QoE model is calculated as the weighted average of the selected WebRTC parameters, where the weights are the average correlation coefficients obtained in the previous section. As described above, the weight may be decreased for content dependent parameters.

In some embodiments, the cross correlation can be taken into account by decreasing the weights of the correlating parameters proportionally with the cross correlation, or by subtracting the cross correlation from the weighted average of the selected WebRTC parameters.

In some embodiments, after normalizing each parameter, the normalized QoE function may be obtained as:

$${QoE}_{norm} = {\sum }_{i}^{n} {w}_{i} {P}_{i} - {\sum }_{jk}^{nn} {c}_{jk} {P}_{j} {P}_{k} , \qquad Eq . ( 1 )$$

Where wᵢ is the average correlation coefficient for the different degradations of WebRTC parameter Pᵢ, where cⱼₖ is the correlation coefficient between parameters Pⱼ and Pₖ, each of i, n, k, j is a number, and a cross correlation among WebRTC parameters cⱼₖPⱼPₖ is subtracted from a weighted average of the selected WebRTC parameters of the WebRTC parameters wᵢPᵢ.

The above function is an example, other nonlinear functions, including conditions determined e.g. by domain knowledge, could also be applied in order to improve accuracy of the model.

### Fitting the Objective and Subjective QoE Models

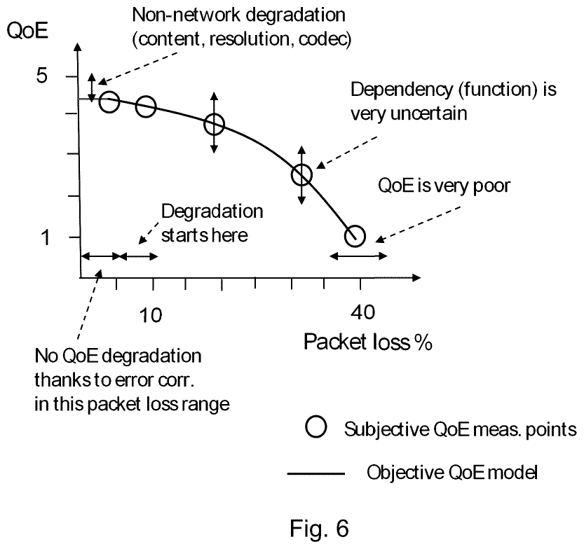

FIG. 6. illustrates an example fitting the Objective QoE model to Subjective QoE at cardinal measurement points, according to certain embodiments. In some embodiments, Subjective QoE are measured by the method and protocol described in “subjective test methodology for assessing impact of initial loading delay on quality of experience, Recommendation ITU-T P.917” or any other suitable method, at certain measurement cardinal points (See FIG. 6.) These measurement cardinal points can be:

Good network conditions, no degradation, according to certain embodiments. In this case, the measured QoE indicates the maximum QoE which can be achieved with the given codecs, terminal type, etc.

For each degradation types, the degradation level, where QoE starts to be degraded or decline, according to certain embodiments. For example, in such cases, the measurement cardinal points may be when the rate of change (i.e., derivative) of the QoE is negative or a negative value less than a threshold value.

For each degradation types, the degradation level, where service quality is completely bad, i.e. QoE is 1 in the scale of 1 to 5, 1 being the least QoE, 5 being the best QoE, according to certain embodiments.

Some intermediate points for single degradation, i.e. only packet loss, or multiple degradations, i.e. jitter and packet loss applied, according to certain embodiments.

Cardinal measurement points can be obtained also for mixed degradation cases as well. The normalized QoE is fitted to these measurement points. In some embodiments, this function results in a QoE value in the score range of 1 to 5, where score 1 is the least QoE and score 5 is the best QoE. In other embodiments, any suitable score range may be defined for the QoE value for the objective QoE function.

QoE for intermediate points are determined by this fitted function (solid curve shown in FIG. 6). Note that the examine of FIG. 6 shows only the packet loss dimension. In practice, the objective QoE function is a multidimensional function, where the dimensions are the degradation types.

### Training the End-to-End QoE Model

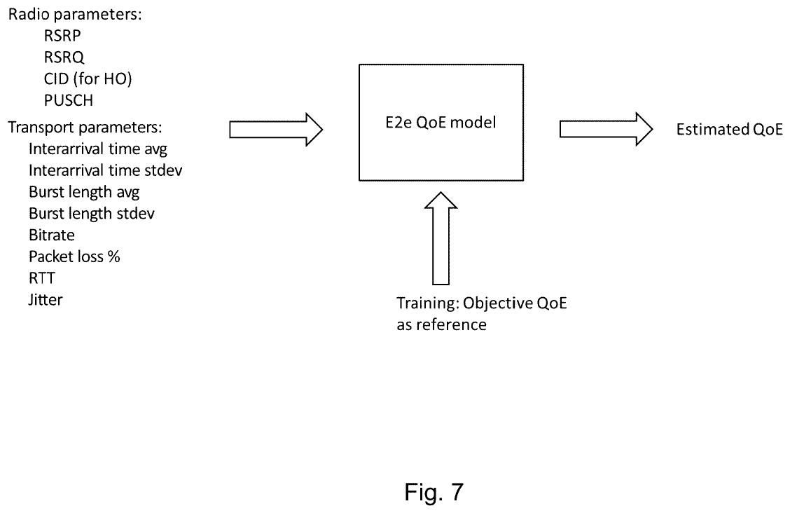

FIG. 7 illustrates an example end-to-end service quality model, according to certain embodiments. In some embodiments, the end-to-end service quality model uses the selected transport and radio parameters as input. For training the model, supervised learning is applied. The time series measurements of the test sessions of these parameters are used as input and the Objective QoE values (based on the measured values of the selected WebRTC parameters) are used as reference values as shown in FIG. 7.

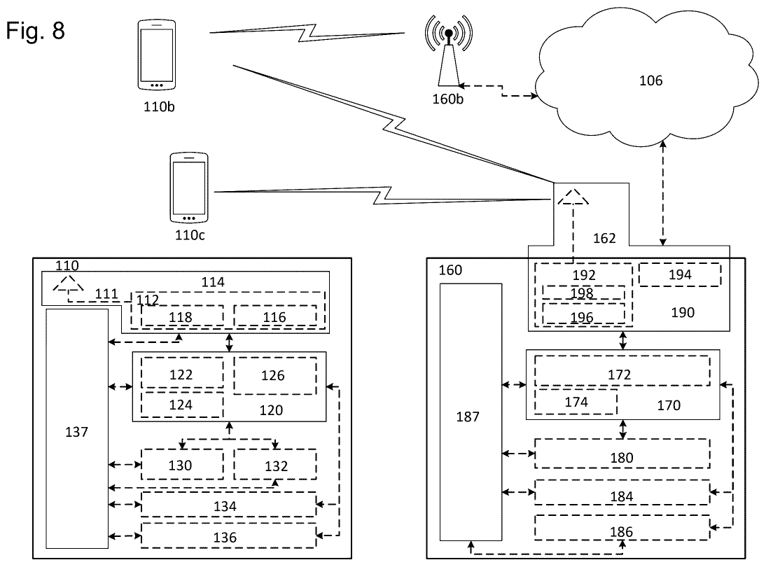

FIG. 8 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 160 includes processing circuitry 170, device readable medium 180, interface 190, auxiliary equipment 184, power source 186, power circuitry 187, and antenna 162. Although network node 160 illustrated in the example wireless network of FIG. 8 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g., refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

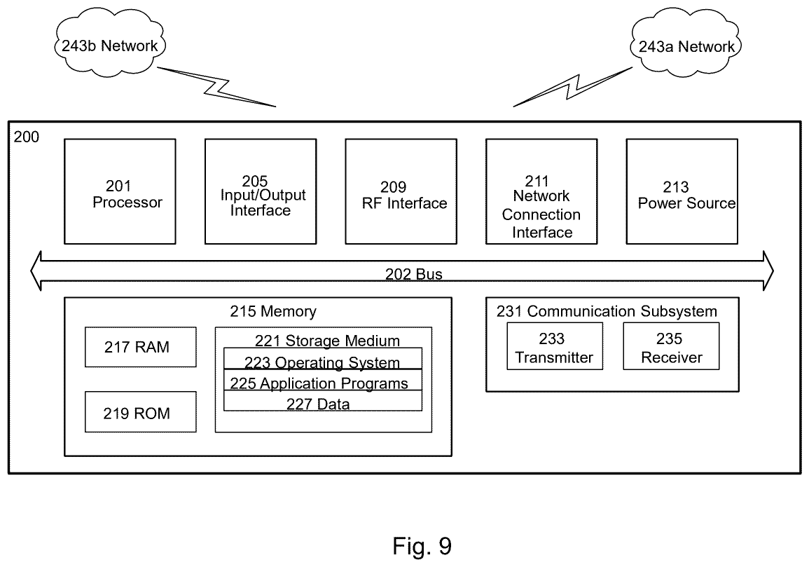

FIG. 9 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 9, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 9, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

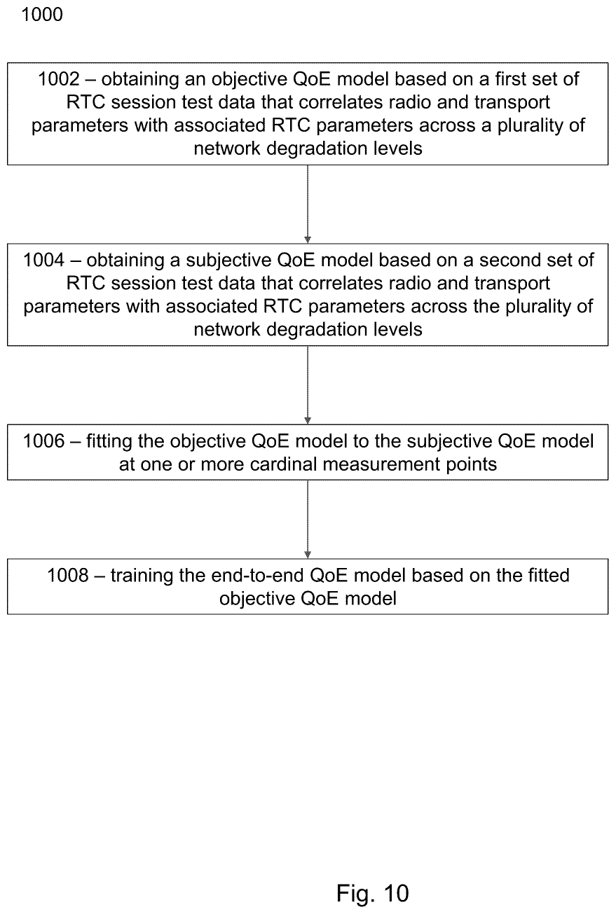

FIG. 10 illustrates an example flow diagram for a method 1000 for training an end-to-end QoE machine learning model for encrypted RTC traffic (e.g., WebRTC) according to one or more embodiments of the present disclosure. In particular embodiments, one or more steps of method 1000 may be performed by network node 160 described with respect to FIG. 8, a core network node, or any other network node capable of training a machine learning model.

The method 1000 may begin at step 1002, where the network node (e.g., network node 160 or any of the suitable network node) obtains an objective QoE model based on a first set of RTC session test data that correlates radio and transport parameters with associated RTC parameters across a plurality of network degradation levels.

The first set of test data may be obtained automatically and may be obtained by any of the procedures described by the embodiments and examples described herein.

In particular embodiments, the radio parameters comprise at least one of RSRP, RSRQ, CID for handover, PUSCH transmit power; and PUCCH transmit power.

In particular embodiments, the transport parameters may comprise at least one of an average or standard deviation interarrival time, an average or standard deviation burst length, a bitrate, a packet loss percentage, an average RTT, and an average jitter.

In particular embodiments, the RTC parameters may comprise at least one of currentRoundTripTime, jitter, packetsSent, packetLost,availableOutgoingBitrate, jitterBufferDelay_diff, sumOfSquaredFramesDuration_diff, interFrameDelayStDev_in_ms, jitterBufferDelay/jitterBufferEmittedCount_in_ms, jitterBufferDelay_diff, framesReceived, and framesReceived/framesDecoded.

In particular embodiments, the plurality of network degradation levels is based on any one or more of the following parameters: packet loss, jitter, bandwidth limitation, bit corruption, radio shielding, coverage less than a threshold, and handover with different level of network degradations.

In particular embodiments, the objective QoE model may be determined based at least on a weighted average of the RTC parameters. The weighted average of the RTC parameters may be determined based at least on weight values that correspond to average correlation coefficients between each of the RTC parameters, each of the radio and transport parameters, and at least one network degradation parameter.

In particular embodiments, the objective QoE function is as below:

$${QoE}_{norm} = {\sum }_{i}^{n} {w}_{i} {P}_{i} - {\sum }_{jk}^{nn} {c}_{jk} {P}_{j} {P}_{k}$$

where, QoEₙₒᵣₘ is a normalized objective QoE value, Wᵢ is an average correlation coefficient for at least one network degradation level and an associated RTC parameter Pᵢ, Cⱼₖ is a correlation coefficient between RTC parameters Pⱼ and Pₖ, each of i, n, k, j is a number, and a cross correlation among RTC parameters cⱼₖPⱼPₖ is subtracted from a weighted average of a subset of RTC parameters wᵢPᵢ.

In particular embodiments, correlating radio and transport parameters with associated RTC parameters across the plurality of network degradation levels comprises excluding a content-dependent RTC parameter from consideration or assigning a first weight value to a content-dependent RTC parameter and assigning a second weight value to other RTC parameters, wherein the first weight value is less than the second weight value.

At step 1004, the network node obtains a subjective QoE model based on a second set of RTC session test data that correlates radio and transport parameters with associated RTC parameters across a plurality of network degradation levels, where the second set of RTC session test data comprises fewer test sessions than the first set of RTC session test data.

The second set of test data may be obtained through subjective evaluation and may be obtained by any of the procedures described by the embodiments and examples described herein. The second set of test data may be more accurate, but more difficult to obtain. Thus, the second set of test data is much smaller than the first set of test data.

At step 1006, the network node fits the objective QoE model to the subjective QoE model at one or more cardinal measurement points. In this way, the network node improves the quality of the objective model based on the subjective test data.

In particular embodiments, the one or more cardinal measurement points comprises at least one of the following: a first point where no network degradation is injected into the encrypted RTC traffic, a second point where an objective QoE value starts to degrade for a given network degradation, a third point where an objective QoE value has the least value, and one or more intermediate points between each pair of the first point, the second point, and the third point.

In particular embodiments, the network node may fit the objective QoE model to the subjective QoE model according to any of the embodiments and examples described herein.

At step 1008, the network node obtains the end-to-end QoE model based on the fitted objective QoE model.

Modifications, additions, or omissions may be made to the method of FIG. 10. Additionally, one or more steps in the method of FIG. 10 may be performed in parallel or in any suitable order.

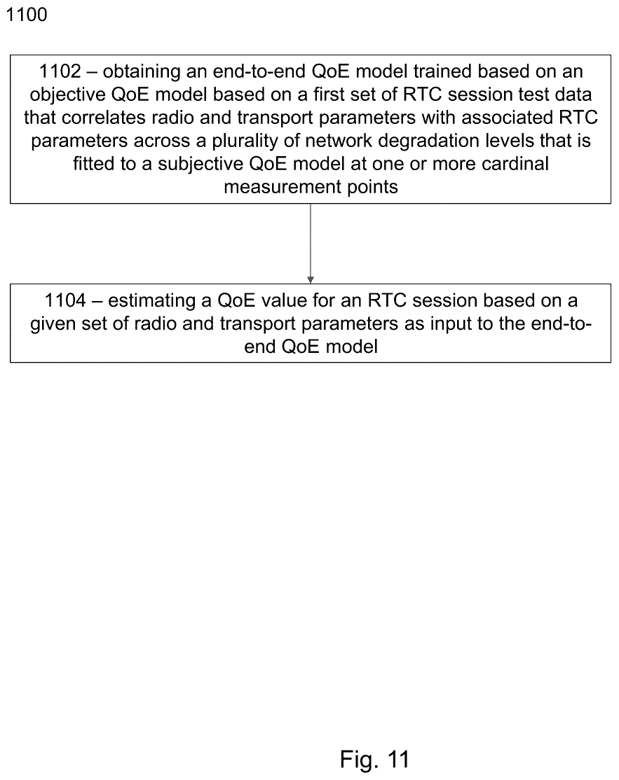

FIG. 11 illustrates an example flow diagram for a method 1100 for determining an end-to-end QoE estimation of encrypted RTC traffic according to one or more embodiments of the present disclosure. In particular embodiments, one or more steps of method 1100 may be performed by network node 160 described with respect to FIG. 8, a core network node, or any other suitable network node.

The method 1100 may begin at step 1102, where the network node (e.g., network node 160) obtains an end-to-end QoE model trained based on an objective QoE model based on a first set of RTC session (e.g., WebRTC) test data that correlates radio and transport parameters with associated RTC parameters across a plurality of network degradation levels that is fitted to a subjective QoE model at one or more cardinal measurement points. The subjective QoE model may be based on a second set of RTC session test data that correlates radio and transport parameters with associated RTC parameters across the plurality of network degradation levels. The second set of RTC test session data may comprise fewer test sessions than the first set of RTC session test data.

At step 1104, the network node estimates a QoE value for an RTC session based on a given set of radio and transport parameters as input to the end-to-end QoE model.

In particular embodiments, the radio parameters comprise at least one of RSRP, RSRQ, CID for handover, PUSCH transmit power; and PUCCH transmit power.

In particular embodiments, the transport parameters may comprise at least one of an average or standard deviation interarrival time, an average or standard deviation burst length, a bitrate, a packet loss percentage, an average RTT, and an average jitter.

In particular embodiments, the RTC parameters may comprise at least one of currentRoundTripTime, jitter, packetsSent, packetLost,availableOutgoingBitrate, jitterBufferDelay_diff, sumOfSquaredFramesDuration_diff, interFrameDelayStDev_in_ms, jitterBufferDelay/jitterBufferEmittedCount_in_ms, jitterBufferDelay_diff, framesReceived, and framesReceived/framesDecoded.

In particular embodiments, the plurality of network degradation levels is based on any one or more of the following parameters: packet loss, jitter, bandwidth limitation, bit corruption, radio shielding, coverage less than a threshold, and handover with different level of network degradations.

In particular embodiments, the objective QoE model may be determined based at least on a weighted average of the RTC parameters. The weighted average of the RTC parameters may be determined based at least on weight values that correspond to average correlation coefficients between each of the RTC parameters, each of the radio and transport parameters, and at least one network degradation parameter.

In particular embodiments, the objective QoE function is as below:

$${QoE}_{norm} = {\sum }_{i}^{n} {w}_{i} {P}_{i} - {\sum }_{jk}^{nn} {c}_{jk} {P}_{j} {P}_{k}$$

where, QoEₙₒᵣₘ is a normalized objective QoE value, Wᵢ is an average correlation coefficient for at least one network degradation level and an associated RTC parameter Pᵢ, Cⱼₖ is a correlation coefficient between RTC parameters Pⱼ and Pₖ, each of i, n, k, j is a number, and a cross correlation among RTC parameters cⱼₖPⱼPₖ is subtracted from a weighted average of a subset of RTC parameters wᵢPᵢ.

In particular embodiments, correlating radio and transport parameters with associated RTC parameters across the plurality of network degradation levels comprises excluding a content-dependent RTC parameter from consideration or assigning a first weight value to a content-dependent RTC parameter and assigning a second weight value to other RTC parameters, wherein the first weight value is less than the second weight value.

In particular embodiments, the plurality of network degradation levels is based on any one or more of the following parameters: packet loss, jitter, bandwidth limitation, bit corruption, radio shielding, coverage less than a threshold, and handover with different level of network degradations.
the one or more cardinal measurement point comprises at least one of the following: a first point where no network degradation is injected into the encrypted RTC traffic, a second point where an objective QoE value starts to degrade for a given network degradation, a third point where an objective QoE value has the least value, and one or more intermediate points between each pair of the first point, the second point, and the third point.

Modifications, additions, or omissions may be made to the method of FIG. 11. Additionally, one or more steps in the method of FIG. 11 may be performed in parallel or in any suitable order.

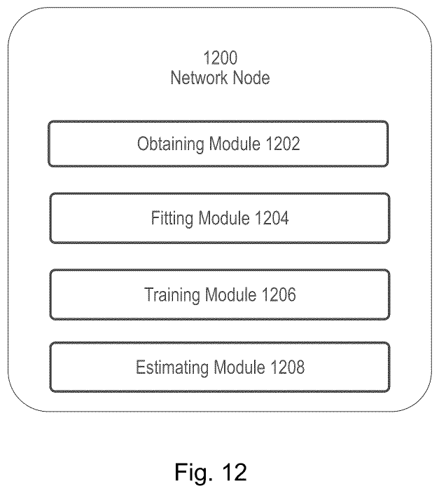

FIG. 12 illustrates a schematic block diagram of a wireless network (for example, the wireless network illustrated in FIG. 8). The apparatus includes a wireless node (e.g., network node 160 illustrated in FIG. 8). Apparatus 1200 is operable to carry out the example methods described with reference to FIGS. 1-11 and possibly any other processes or methods disclosed herein. It is also to be understood that the methods of FIGS. 11 and 12 are not necessarily carried out solely by apparatus 110. At least some operations of any of the method may be performed by one or more other entities.

Virtual apparatus 1200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause obtaining module 1202, fitting module 1204, training module 1206, estimating module 1208, and any other suitable units of apparatus 1200 to perform corresponding functions according to one or more embodiments of the present disclosure.

As illustrated in FIG. 12, apparatus 1200 includes obtaining module 1202 configured to obtain an objective QoE model based on a first set of RTC session test data that correlates radio and transport parameters with associated RTC parameters across a plurality of network degradation levels according to any of the embodiments and examples described herein. The obtaining module 1202 may further be configured to obtain a subjective QoE model based on a second set of RTC session test data that correlates radio and transport parameters with associated RTC parameters across a plurality of network degradation levels, where the second set of RTC session test data comprises fewer test sessions than the first set of RTC session test data according to any of the embodiments and examples described herein. Fitting module 1204 may be configured to fit the objective QoE model to the subjective QoE model at one or more cardinal measurement points according to any of the embodiments and examples described herein. Training module 1206 may be configured to train the end-to-end QoE model based on the fitted objective QoE model according to any of the embodiments and examples described herein.

Obtaining module 1202 may further be configured to obtain an end-to-end QoE model trained based on an objective QoE model based on a first set of RTC session test data that correlates radio and transport parameters with associated RTC parameters across a plurality of network degradation levels that is fitted to a subjective QoE model at one or more cardinal measurement points according to any of the embodiments and examples described herein. The subjective QoE model may be based on a second set of RTC session test data that correlates radio and transport parameters with associated RTC parameters across a plurality of network degradation levels according to any of the embodiments and examples described herein. The second set of RTC test session data may comprise fewer test sessions than the first set of RTC session test data according to any of the embodiments and examples described herein. Estimating module 1208 may be configured to estimating a QoE value for an RTC session based on a given set of radio and transport parameters as input to the end-to-end QoE model according to any of the embodiments and examples described herein.

Any of the modules 1202 to 1208 may further be configured to communicate media items associated with the at least one encrypted WebRTC traffic to a set of user devices, and obtain a set of subjective QoE scores from the set of user devices according to any of the embodiments and examples described herein.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific example embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1.-40. (canceled)

41. A method performed by a network node for training an end-to-end quality of experience (QoE) machine learning model for encrypted real-time communication (RTC) traffic, the method comprising:
obtaining an objective QoE model based on a first set of RTC session test data that correlates radio and transport parameters with associated RTC parameters across a plurality of network degradation levels;
obtaining a subjective QoE model based on a second set of RTC session test data that correlates radio and transport parameters with associated RTC parameters across the plurality of network degradation levels, wherein the second set of RTC session test data comprises fewer test sessions than the first set of RTC session test data;
fitting the objective QoE model to the subjective QoE model at one or more cardinal measurement points; and
training the end-to-end QoE model based on the fitted objective QoE model.

42. The method of claim 41, wherein the objective QoE model is determined based at least on a weighted average of the RTC parameters, wherein the weighted average of the RTC parameters is determined based at least on weight values that correspond to average correlation coefficients between each of the RTC parameters, each of the radio and transport parameters, and at least one network degradation parameter.

43. The method of claim 41, wherein correlating radio and transport parameters with associated RTC parameters across the plurality of network degradation levels comprises excluding a content-dependent RTC parameter from consideration.

44. The method of claim 41, wherein correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.

45. A network node capable of training an end-to-end quality of experience (QoE) machine learning model for encrypted real-time communication (RTC) traffic, the network node comprising a processing circuitry configured to:
obtain an objective QoE model based on a first set of RTC session test data that correlates radio and transport parameters with associated RTC parameters across a plurality of network degradation levels;
obtain a subjective QoE model based on a second set of RTC session test data that correlates radio and transport parameters with associated RTC parameters across the plurality of network degradation levels, wherein the second set of RTC session test data comprises fewer test sessions than the first set of RTC session test data;
fit the objective QoE model to the subjective QoE model at one or more cardinal measurement points; and
train the end-to-end QoE model based on the fitted objective QoE model.

46. The network node of claim 45, wherein the objective QoE model is determined based at least on a weighted average of the RTC parameters, wherein the weighted average of the RTC parameters is determined based at least on weight values that correspond to average correlation coefficients between each of the RTC parameters, each of the radio and transport parameters, and at least one network degradation parameter.

47. The network node of claim 45, wherein correlating radio and transport parameters with associated RTC parameters across the plurality of network degradation levels comprises excluding a content-dependent RTC parameter from consideration.

48. The network node of claim 45, wherein correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.

49. A method performed by a network node for determining an end-to-end quality of experience (QoE) estimation of encrypted real-time communication (RTC) traffic, the method comprising:
obtaining an end-to-end QoE model trained based on an objective QoE model based on a first set of RTC session test data that correlates radio and transport parameters with associated RTC parameters across a plurality of network degradation levels that is fitted to a subjective QoE model at one or more cardinal measurement points, wherein the subjective QoE model is based on a second set of RTC session test data that correlates radio and transport parameters with associated RTC parameters across the plurality of network degradation levels, wherein the second set of RTC test session data comprises fewer test sessions than the first set of RTC session test data; and
based on a given set of radio and transport parameters as input to the end-to-end QoE model, estimating a QoE value for an RTC session.

50. The method of claim 49, wherein the objective QoE model is determined based at least on a weighted average of the RTC parameters, wherein the weighted average of the RTC parameters is determined based at least on weight values that correspond to average correlation coefficients between each of the RTC parameters, each of the radio and transport parameters, and at least one network degradation parameter.

51. The method of claim 49, wherein correlating radio and transport parameters with associated RTC parameters across the plurality of network degradation levels comprises excluding a content-dependent RTC parameter from consideration.

52. The method of claim 49, wherein correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.

53. A network node capable of determining an end-to-end quality of experience (QoE) estimation of encrypted real-time communication (RTC) traffic, the network node comprising a processing circuitry configured to:
obtain an end-to-end QoE model trained based on an objective QoE model based on a first set of RTC session test data that correlates radio and transport parameters with associated RTC parameters across a plurality of network degradation levels that is fitted to a subjective QoE model at one or more cardinal measurement points, wherein the subjective QoE model is based on a second set of RTC session test data that correlates radio and transport parameters with associated RTC parameters across the plurality of network degradation levels, wherein the second set of RTC test session data comprises fewer test sessions than the first set of RTC session test data; and
based on a given set of radio and transport parameters as input to the end-to-end QoE model, estimate a QoE value for an RTC session.

54. The network node of claim 53, wherein the objective QoE model is determined based at least on a weighted average of the RTC parameters, wherein the weighted average of the RTC parameters is determined based at least on weight values that correspond to average correlation coefficients between each of the RTC parameters, each of the radio and transport parameters, and at least one network degradation parameter.

55. The network node of claim 53, wherein correlating radio and transport parameters with associated RTC parameters across the plurality of network degradation levels comprises excluding a content-dependent RTC parameter from consideration.

56. The network node of claim 53, wherein correlating radio and transport parameters with associated RTC parameters across the plurality of network degradation levels comprises assigning a first weight value to a content-dependent RTC parameter and assigning a second weight value to other RTC parameters, wherein the first weight value is less than the second weight value.
